(19) United States
(12) Patent Application Publication
(10) Pub. No.: US 2008/0160483 A1
(43) Pub. Date: Jul. 3, 2008

(54) Dental implant

(76) Inventors: Karl-Heinz Danger, Detmold (DE); Michael Krumsiek, Lemgo (DE); Hans-Jurgen Hartmann, Tutzing (DE)

Correspondence Address: BLISS MCGLYNN, P.C., 2075 WEST BIG BEAVER ROAD, SUITE 600, TROY, MI, 48084, US

(21) Appl. No.: 12/008,773

(22) Filed: Jan. 14, 2008

Related U.S. Application Data
(63) Continuation of application No. PCT/EP2006/005748, filed on Jun. 14, 2005.

(30) Foreign Application Priority Data
Jul. 14, 2005 (DE) 10 2005 032938.1

(51) Int. Cl. A61C 8/00

(52) U.S. Cl. 433/174

(57) ABSTRACT

A one-part dental implant has an enossal portion made of a metallic material and a coronal portion made of a ceramic material. The enossal portion is integrally connected to the coronal portion, wherein a connection portion between the coronal portion and the enossal portion is formed gap-free. The coronal portion and the enossal portion is in a form-fit engagement and a connection between the coronal portion and the enossal portion is formed as a force-fit joining connection.

### CROSS-REFERENCE TO RELATED APPLICATIONS

This application claims the benefit under 35 U.S.C. § 365(c) of PCT International Application Serial No. PCT/EP2006/005748, filed Jun. 14, 2006.

### BACKGROUND OF THE INVENTION

1. Field of the Invention

The present invention relates to a dental implant.

2. Description of the Related Art

It is known to provide a dental implant having an enossal portion and a coronal portion. The enossal portion is screwed into the patient's jaw-bone, whereas a setup, such as for example a crown, is mounted onto the coronal portion. Dental implants or tooth implants of the mentioned kind are known from the state of the art in different embodiments. Examples are shown in DE 102 51 469 A1.

From the state of the art, one-part dental implants or jaw implants are known, which are, for example, made of titanium. In this context, it may be disadvantageous that the metallic material causes undesired reactions of the patient in the transitional area between the enossal portion and the coronal portion, i.e. in the portion in which the teethridge abuts against the dental implant, or is not desired for optical reasons.

Furthermore, the state of the art discloses two-part dental implants, for example having an enossal portion made of titanium and a coronal portion made of ceramics. Therein, the enossal portion is first inserted into a jaw-bone in order to ingrow therein. In a second step, the coronal portion is attached to the enossal portion. This is performed by screwing or bonding. The joining area, in this case, lies in the area of the toothridge. This results in the problem that, on the one hand, no gap-free processing is possible and that, on the other hand, residues of the adhesive may escape or protrude. Both causes undesired reactions of the patient.

WO 01/34056 A1 discloses a variation of a one-part metallic dental implant which is provided with a ceramic coating in its coronal portion. Dependent on the material of the crown, it is herein disadvantageous that the metallic core, which serves to transmit force and to fix the setup or the crown, may shine through optically, such that the appearance of the dental implant is disadvantageous.

From DE 196 38 232 A1, a dental implant is known, wherein an implant part is made of titanium and a base part is made of ceramics, both parts being connected by an adhesive bond which forms a sealed transition and fills and seals cavities. The joining surface is planar such that problems may occur in view of strength.

WO 2004/054464 A shows an abutment for a tooth implant, wherein the abutment is bonded with the implant part in situ. For this purpose, a pin of the abutment projects into a recess of a shaft.

A similar construction is shown in DE 40 19 846 A1. Also in this case, the setup post is provided with a pin which is glued into a central recess of a main part. Also in this case, there is no prefabricated unit. In addition, all components are made of ceramics.

U.S. Pat. No. 5,947,732 describes a dental implant, wherein the abutment is fixed to the implant part merely by a screw. A pre-assembly is not provided. A similar construction is shown in U.S. Pat. No. 5,447,435. Also from WO 97/30654 A, it is known to screw the individual components in situ, in order to connect a titanium implant to an abutment. The same technical solution is shown in EP 0 477 644 A.

### SUMMARY OF THE INVENTION

It is an object of the present invention to provide a dental implant of the aforementioned kind, which may be easily inserted by a dentist and avoids the drawbacks of the state of the art while having a simple structure and a simple and cost-effective producibility.

According to the present invention, the object is solved by the combination of features of the main claim, the sub-claims show further advantageous embodiments of the invention.

According to the present invention, a dental implant is formed integrally or in one part, wherein the enossal portion is made of a metallic material and is connected integrally with the coronal portion which is made of a ceramic material. The inventive dental implant is thus finished in the factory and may be inserted directly by the dentist. It is not required to assemble parts during the operation. Therewith, it is also prevented that the assembly of the coronal portion onto the enossal portion is not performed correctly. In particular, the formation of a gap between the enossal portion and the coronal portion is excluded, since this may be reliably monitored during the factory-made production. In addition, it is prevented that an adhesive or any other bonding material, which is inevitably present in the transitional area of a two-part dental implant being assembled by a dentist, escapes and may in particular enter into the bone, where it may cause strong reactions and problems for the patient.

The inventive dental implant is thus pre-produced in the factory and may be formed such that a setup or a crown may be mounted directly onto the coronal portion or that the coronal portion must be processed only slightly. In both cases, the working time of the dentist is shortened, such that the inventive dental implant may be inserted economically. In addition, mistakes during the assembly of the dental implant and its insertion are excluded. Consequently, as a whole, a high degree of comfort and security is achieved.

The transitional area between the coronal portion and the enossal portion is formed completely gap-free according to the present invention. This may be achieved by a post-processing of this portion, for example by polishing or grinding, and may be secured by appropriate monitoring.

Within the scope of the present invention, there result different embodiments for the connecting portion. The same is produced as a force-fit joining connection, for example by welding, soldering, or bonding. It is further provided to form the connecting portion in a form-fit manner, in addition to a welding, bonding, or soldering process. The form-fit coupling results in an increased mechanical strength. It is also possible to couple the coronal portion and the enossal portion by a thread or a bayonet joint and to subsequently bond, weld, or solder the parts, if required. Also, an increased mechanical strength is achieved, in particular in a coronal portion made of a ceramic material.

Furthermore, it is provided within the scope of the present invention that the coronal portion and the enossal portion engage in a form-fit manner, for example by concave or convex partial portion. Therewith, also the joining surface is enlarged, such that the mechanical load capacity may be increased.

It is particularly preferable if the inventive dental implant is dimensioned such that the connecting portion between the coronal portion and the enossal portion, when the dental implant is inserted, lies within the gingival area of the patient. Preferably, the toothridge abuts substantially against the ceramic material of the coronal portion. This serves, on the one hand, to enhance the optical appearance and, on the other hand, to enhance the physical and medical acceptance by the patient.

The enossal portion is preferably provided with at least one external thread, as it is known from the state of the art.

The structure and design of the coronal portion may be adapted to the respective requirements. It is, for example, possible to adapt the same to the respective shape of the tooth, in order to facilitate the setup of the tooth or the attachment of a crown.

Other objects, features, and advantages of the present invention will be readily appreciated, as the same becomes better understood, after reading the subsequent description taken in conjunction with the accompanying drawings.

### BRIEF DESCRIPTION OF THE DRAWINGS

FIG. 1 is a longitudinal sectional view of one embodiment of a dental implant, according to the present invention.

FIG. 2 is a sectional view taken along line A-A of FIG. 1.

FIG. 3 is a perspective exploded side view of a further embodiment of the dental implant, according to the present invention.

### DESCRIPTION OF THE PREFERRED EMBODIMENT(S)

Referring now to the drawings, one embodiment of a dental implant, according to the present invention, is shown. The dental implant has an enossal portion made of a metallic material, e.g. titanium. At their outsides, the embodiments respectively have a three-part external thread 5 having different outer diameters as well as different forms of the thread, as it is known from the state of the art.

The dental implant also has a coronal portion 2 integrally connected to the enossal portion 1, the coronal portion being made of a ceramic material, e.g. zirconium oxide ceramics. However, it is also possible to use other ceramic materials or mixed ceramics or diffusion ceramics.

The enossal portion 1 and the coronal portion 2 are integrally connected in the area of a connecting portion 3. The connecting portion 3 may be formed by soldering, welding, or bonding.

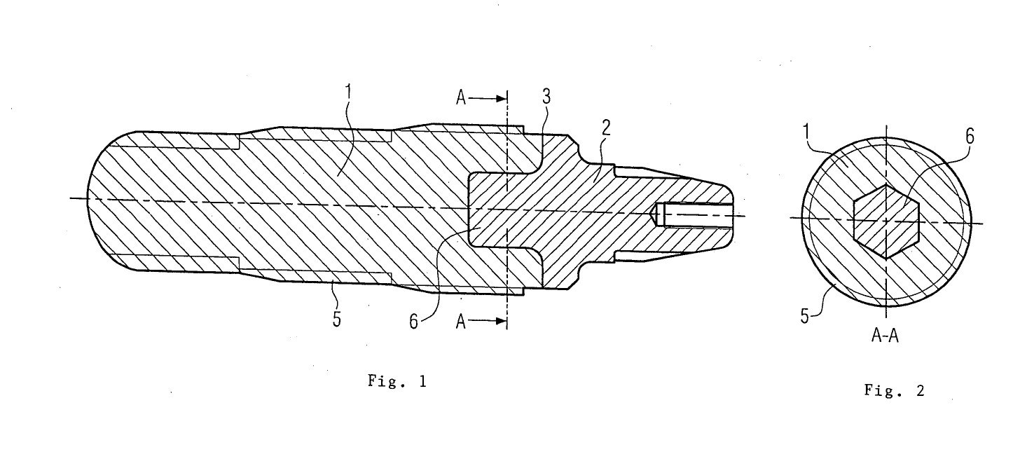

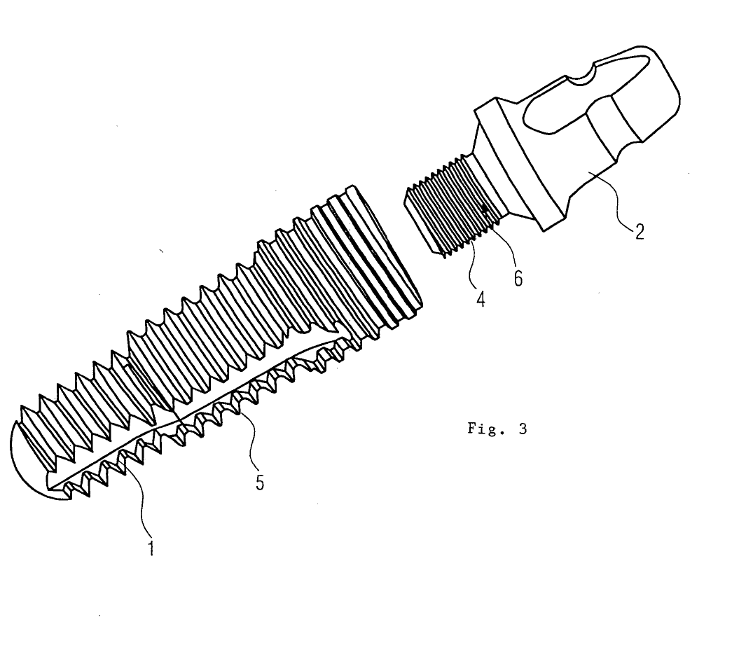

The embodiment shown in FIG. 1 provides a pin 6 at the coronal portion 2, the pin 6 being insertable into an exactly fitting recess of the enossal portion 1. The pin 6 may also be shaped structured, e.g. as a hexagon, in order to additionally provide a locking device by positive fit, as is discernible from FIG. 2.

The embodiment of FIG. 3 shows a variation in which the pin 6 is provided with a thread 4, wherein the recess of the enossal portion 1 is provided with an internal thread (not shown). In addition to a screwing of the thread, a bonding, soldering, or welding is performed to realize a gap-free connecting portion 3.

As far as the connection is performed according to FIG. 1 and FIG. 3, the cylinder projecting into the bore of the titanium part should be provided with a decompression groove or surface, such that the adhesive material in the bore may escape during the joining until the final placement is reached.

The present invention has been described in an illustrative manner. It is to be understood that the terminology, which has been used, is intended to be in the nature of words of description rather than of limitation.

Many modifications and variations of the present invention are possible in light of the above teachings. Therefore, within the scope of the appended claims, the present invention may be practiced other than as specifically described.

What is claimed is:

1. A one-part dental implant comprising:
an enossal portion made of a metallic material;
a coronal portion made of a ceramic material;
said enossal portion being integrally connected to said coronal portion, wherein a connection portion between said coronal portion and said enossal portion is formed gap-free; and
said coronal portion and said enossal portion being in a form-fit engagement and a connection between said coronal portion and said enossal portion is formed as a force-fit joining connection.

2. A one-part dental implant as set forth in claim 1 wherein the connection between said coronal portion and said enossal portion is formed as a form-fit connection.

3. A one-part dental implant as set forth in claim 1 wherein the connection between said coronal portion and said enossal portion is formed as a bond connection.

4. A one-part dental implant as set forth in claim 1 wherein the connection between said coronal portion and said enossal portion is formed as a soldering connection.

5. A one-part dental implant as set forth in claim 1 wherein the connection between said coronal portion and said enossal portion is formed as a welding connection.

6. A one-part dental implant as set forth in claim 1 wherein said coronal portion and said enossal portion are in engagement by at least one concave and one convex partial portion.

7. A one-part dental implant as set forth in claim 2 wherein the connection is performed by a thread.

8. A one-part dental implant as set forth in claim 2 wherein the connection is performed by a bayonet joint.

9. A one-part dental implant as set forth in claim 1 wherein said connecting portion between said coronal portion and said enossal portion is dimensioned to be arranged in the gingival area of a patient.

10. A one-part dental implant as set forth in claim 1 wherein said enossal portion is provided with at least one external thread.

11. A one-part dental implant as set forth in claim 1 wherein said coronal portion is pre-structured to receive a crown.

12. A one-part dental implant as set forth in claim 3 wherein at least one of said enossal portion and said coronal portion is provided with a decompression groove in their contact portions.
